(19) United States
(12) Patent Application Publication
(10) Pub. No.: US 2019/0276136 A1
(43) Pub. Date: Sep. 12, 2019

(54) TORSION BOX FOR AIRCRAFT FORMED BY PAIR-WELDED ELEMENTS AND METHOD FOR PRODUCING SAME

(71) Applicant: Airbus Operations SAS, Toulouse (FR)

(72) Inventor: Umberto PIROZZI, NANTES (FR)

(21) Appl. No.: 16/293,054

(22) Filed: Mar. 5, 2019

(30) Foreign Application Priority Data
Mar. 9, 2018 (FR) 1852070

(51) Int. Cl. B64C 3/18; B64F 5/10

(52) U.S. Cl. CPC B64C 3/187; B23K 2101/006; B64F 5/10

(57) ABSTRACT

A torsion box for aircraft comprises hollow sections and stiffening ribs, arranged alternately. Each hollow section has two opposing section edges and two opposing respective openings circumscribed by the two section edges respectively. Each hollow section fully surrounds an internal space linking the two openings. Each stiffening rib comprises a web, and a flange which extends from the web all around the web, and which has two flange edges arranged respectively on either side of the web and respectively welded to two of the respective section edges of two corresponding hollow sections.

### CROSS-REFERENCES TO RELATED APPLICATIONS

This application claims the benefit of the French patent application No. 1852070 filed on Mar. 9, 2018, the entire disclosures of which are incorporated herein by way of reference.

### FIELD OF THE INVENTION

The present invention relates to the field of the structure of aircraft, and relates more particularly to a torsion box for aircraft and a method for producing such a torsion box. The latter can, in particular, form a center wing box (CWB), and an outboard wing box (OWB).

### BACKGROUND OF THE INVENTION

In an aircraft comprising a fuselage and an airfoil comprising two wings fixed to the fuselage on either side thereof, the fuselage generally incorporates a torsion box, called center wing box, to which are fixed respective torsion boxes of the wings, generally called outboard wing boxes.

Each of these torsion boxes typically comprises a top panel, also called upper surface panel, a bottom panel, also called bottom surface panel, and a front spar and a rear spar which each link the bottom panel to the top panel, such that the assembly of these elements delimits an internal volume of the torsion box.

Each of the torsion boxes generally incorporates stiffening ribs housed in the internal volume of the box and interlinking the bottom and top panels and the front and rear spars of the box.

These torsion boxes support the static and dynamic loads that are exerted on the wings, and, in the case of the center wing box, the bending stresses of the fuselage.

Such a torsion box comprises a large number of parts, and an even greater number of fixing members, such as bolts and/or rivets, for assembling the parts to one another.

Consequently, the weight of a torsion box of this type is relatively high, and the production of such a box requires a large number of assembly operations and of sealing operations between the parts, which is generally reflected in a high cost and a relatively low rate of production.

### SUMMARY OF THE INVENTION

An aim of the invention is, in particular, to provide a simple, economic and effective solution to these problems, that makes it possible to at least partly avoid the abovementioned drawbacks.

To this end, it proposes a torsion box for aircraft, comprising hollow sections and stiffening ribs, arranged alternately one behind the other in a direction of alignment, each hollow section having two opposing respective section edges and two opposing respective openings, circumscribed by the two section edges respectively, each hollow section being shaped so as to fully surround an internal space mutually linking the two openings of the hollow section, and each stiffening rib comprising a respective web, and a respective flange which extends from the web all around the latter, and which has two flange edges arranged respectively on either side of the web and respectively welded to two of the respective section edges of two corresponding hollow sections.

Generally, the invention makes it possible to considerably simplify the production of an aircraft torsion box, in particular through a drastic reduction of the variety of the parts forming the torsion box, and through the production of the torsion box not requiring sealing operations at the joints between the different parts. The configuration of the torsion box also lends itself to the use of simple and efficient production techniques, such as extrusion, with regard to the parts forming the box. In addition, by avoiding the use of a large number of fixing members of bolt or rivet type, the invention also makes it possible to reduce the weight of the torsion box.

Preferably, each hollow section is formed of a single piece.

In preferred embodiments of the invention, each hollow section and the flange of each stiffening rib have corrugations transversely to the direction of alignment.

Preferably, the torsion box also comprises box-beams connected respectively to the respective flanges of the stiffening ribs and extending on one and the same side of the torsion box, outside of an internal volume of the torsion box delimited by the hollow sections and by the respective flanges of the stiffening ribs.

In preferred embodiments of the invention, the torsion box also comprises two end ribs arranged at two opposite ends of the torsion box and fixed respectively to two corresponding hollow sections.

The invention relates also to an aircraft, comprising at least one torsion box of the type described above, forming a center wing box or an outboard wing box.

The invention relates also to a method for producing a torsion box for aircraft, comprising the following steps:

providing of the hollow sections, each having two opposing respective section edges and two opposing respective openings circumscribed by the two section edges respectively, each hollow section being shaped so as to fully surround an internal space mutually linking the two openings of the section,

providing of the stiffening ribs, each comprising a respective web and a respective flange which extends from the web all around the latter, and which has two flange edges arranged respectively on either side of the web,

welding each of the two flange edges of the flange of each stiffening rib to a corresponding section edge of a corresponding hollow section, so as to obtain the torsion box, in which the hollow sections and the stiffening ribs are arranged alternately one behind the other in a direction of alignment.

In a preferred embodiment of the invention, the welding step is implemented by means of a butt-welding technique.

Preferably, the butt-welding technique is chosen from friction stir welding and laser welding.

Preferably, the step of providing the hollow sections comprises the production of the hollow sections by extrusion.

Preferably, the production of the hollow sections by extrusion comprises, for each of the hollow sections, the production by extrusion of individual sections then the assembly of the individual sections by welding.

### BRIEF DESCRIPTION OF THE DRAWINGS

The invention will be better understood, and other details, advantages and features thereof will emerge on reading the following description given as a nonlimiting example and with reference to the attached drawings in which:

FIG. 1 is a perspective schematic view of elements intended to form a torsion box according to a preferred embodiment of the invention;

FIG. 2 is a perspective schematic view of a torsion box according to the preferred embodiment of the invention, formed from the elements of FIG. 1;

FIGS. 3, 4 and 5 are perspective schematic views respectively of a hollow section, of a stiffening rib, and of an end rib, forming part of the elements of FIG. 1;

FIGS. 6 and 7 are perspective schematic views of variant embodiments respectively of a stiffening rib and of a hollow section;

FIG. 8 is a perspective schematic view of an individual section involved in the construction of the hollow section of FIG. 7.

FIG. 9 is a perspective schematic view of an aircraft comprising the torsion box of FIG. 1.

Throughout these figures, identical references can denote identical or similar elements.

### DETAILED DESCRIPTION OF THE PREFERRED EMBODIMENTS

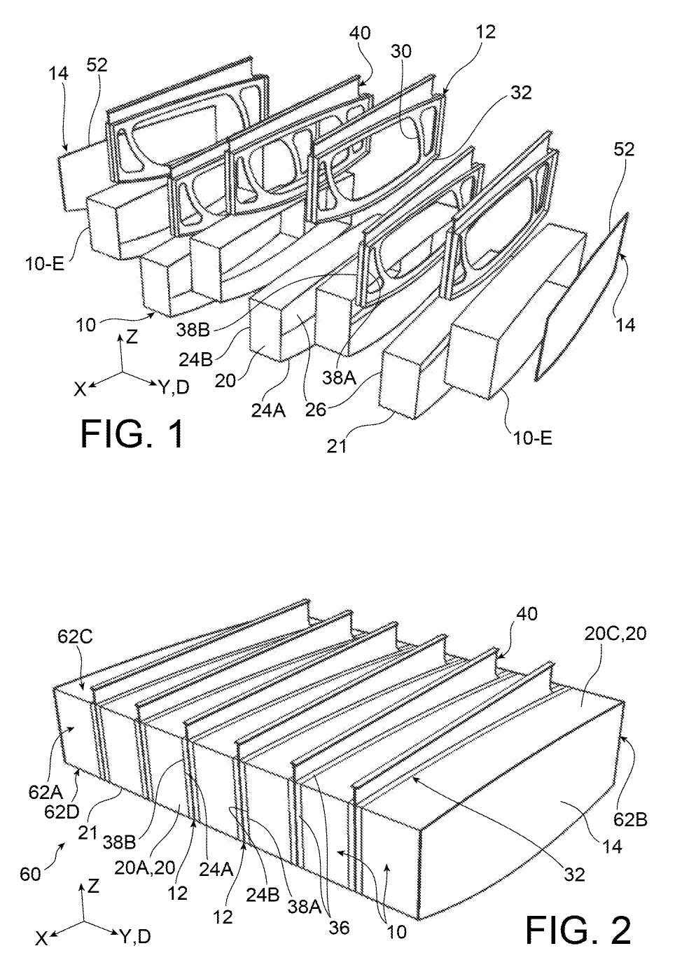

FIG. 1 illustrates the elements intended to be assembled end-to-end to form a torsion box for aircraft according to a preferred embodiment of the invention, for example, a center wing box.

In the following description, the directions X, Y and Z are defined with reference to the orientation planned for the torsion box within an aircraft. The longitudinal direction X is defined conventionally as being parallel to the roll axis of the aircraft, the transverse direction Y as being parallel to the pitch axis of the aircraft, and the vertical direction Z as being parallel to the yaw axis of the aircraft.

The elements that can be seen in FIG. 1 comprise hollow sections 10, for example seven of them, stiffening ribs 12, for example six of them, and two end ribs 14. Generally, the number of stiffening ribs 12 is equal to the number of hollow sections 10 minus one unit.

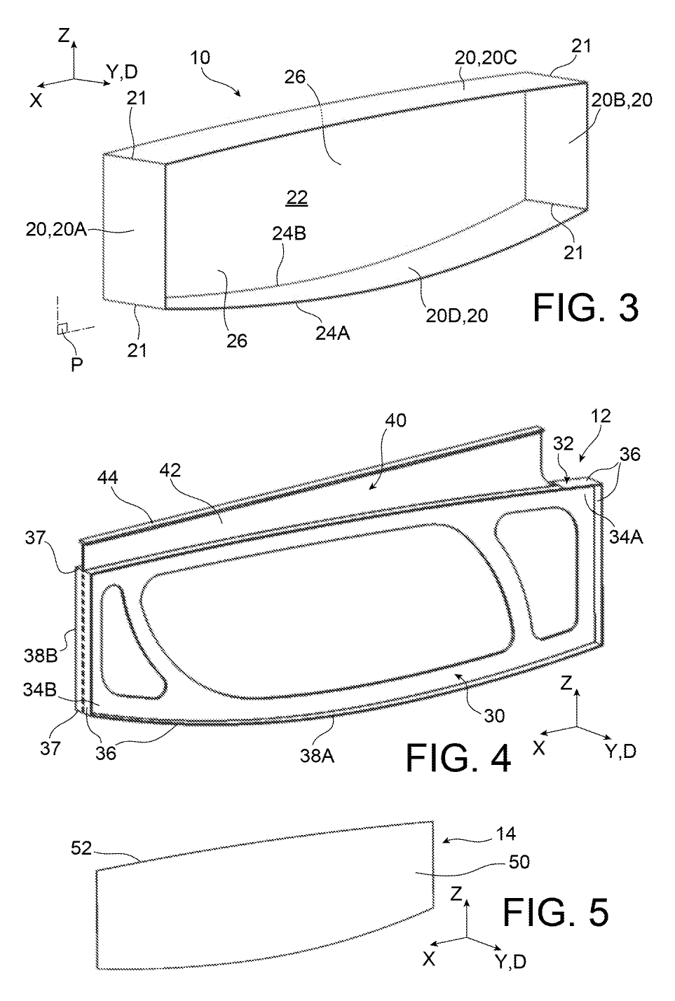

As appears more clearly in FIG. 3, each hollow section 10 has several flat or dished walls 20, preferably four of them, linked in pairs at edges 21 of the section, such that the section has, in a plane P orthogonal to the direction of the edges, a closed section, and thus fully surrounds an internal space 22 of the section. In the example illustrated, the walls 20 comprise a front wall 20A and a rear wall 20B of flat rectangular form, and a top wall 20C and a bottom wall 20D of dished rectangular form.

Thus, each hollow section 10 has two opposing respective section edges 24A, 24B, each formed by a set of respective edges of the walls 20 situated on one and the same side of the hollow section.

Each hollow section 10 therefore also has two opposing respective openings 26, circumscribed by the two section edges 24A, 24B respectively. The internal space 22 thus links the two openings 26 to one another.

The number of walls 20 is identical from one hollow section 10 to another.

The hollow sections 10 are of identical respective forms and are each of constant section, in the case where the torsion box to be produced is of constant section. As a variant, in the case where the torsion box to be produced is of tapered section, the hollow sections 10 can each have a tapered section, and have different sections from one hollow section to another.

The hollow sections 10 are preferably produced in a single piece by extrusion.

As a variant, the hollow sections 10 can be produced from several parts welded in pairs, for example four parts. In this case, for each of the hollow sections 10, the parts, which are preferably each produced by extrusion, advantageously incorporate the corners of the section. For example, each part incorporates a corresponding corner of the hollow section 10, or two of the parts incorporate two corresponding corners while the other two parts incorporate no corner. Thus, the connection of the parts in pairs can be done by a butt-welding technique. This type of technique offers in particular the advantage of better mechanical properties by comparison with the transparency welding techniques which would be necessary if the parts were welded in pairs at the edges of the hollow section.

Referring to FIGS. 1 and 4, each stiffening rib 12 comprises a web 30, and a flange 32, which extends from—and all around—the web 30. The flange 32 forms an end flange of the web 30 extending over all the periphery thereof, on either side of the web. The assembly formed by the web 30 and the flange 32 locally has a substantially T-shaped section, all along the periphery of the web 30.

The web 30 preferably has several openings.

The flange 32, which extends continually around the web 30 so as to have a closed section, is formed by walls 36, joined in pairs at edges 37. The number of the walls 36 of each flange 32 is equal to the number of the walls 20 of each hollow section 10.

The flange 32 has two flange edges 38A, 38B extending respectively on either side of the web 30.

In the embodiment illustrated which relates to a center wing box, each stiffening rib 12 also comprises a box-beam 40 intended to support an aircraft floor. Such a beam extends on a side opposite the side of the web 30, from one of the walls 36 of the flange 32. More specifically, the box-beam 40 comprises, for example, a web 42 having a bottom end connected to a top wall 36 of the flange 32, and a heel 44 extending from the opposite end of the web 42 (that is to say, its top end).

The stiffening ribs 12 can each be produced in a single piece by machining from a single blank.

The end ribs 14 are illustrated highly schematically in FIGS. 1, 2 and 5, in the form of a simple plate 50 having a rib edge 52 (FIG. 5), but these end ribs 14 can have a more complex configuration. In particular, in the embodiment illustrated which relates to a center wing box, the end ribs 14 are intended for the joint between airfoil and center wing box, and are, for example, of the type described in the document US20120286090, which disclosure is incorporated herein by reference.

The above elements 10, 12, 14 having been provided during the steps A and B of a method for producing the torsion box according to the invention, such a method then comprises a step C comprising fixing these elements in pairs by welding, by alternating the hollow sections 10 and the stiffening ribs 12. In the embodiment illustrated, the step C also comprises fixing the two end ribs 14 to the ends of the duly formed assembly.

More specifically, the step C comprises welding each flange edge 34A, 34B of the flange 32 of each stiffening rib 12 to a corresponding section edge 24A or 24B of a hollow section 10, through an alternating arrangement of the hollow sections 10 and of the stiffening ribs 12 one behind the other in a direction of alignment D. The direction of alignment D corresponds to the direction of the edges 21 of each hollow section 10, and to the transverse direction Y defined above.

The welding operations of the step C are preferably butt-welding operations implemented by means of the friction stir welding technique or the laser welding technique.

The step C also comprises fixing each of the two end ribs 14 respectively to the two hollow sections 10-E (FIG. 1) arranged respectively at the ends of the assembly formed by the hollow sections 10 and the stiffening ribs 12. This fixing can be implemented in a conventional manner, by means of bolted or riveted fittings. As a variant, each of the two end ribs 14 can comprise a flange by which said rib is fixed to the corresponding hollow section 10-E by butt-welding, by means of the friction stir welding technique or the laser welding technique.

FIG. 2 illustrates the duly obtained torsion box 60.

This box has a front wall 62A, a rear wall 62B, a top wall 62C and a bottom wall 62D, which are respectively formed by a set of walls 20 of the hollow sections 10 and of walls 36 of the flanges 32 of the stiffening ribs 12, arranged end-to-end. The walls 62A-62D thus delimit an internal volume of the box, comprising the respective internal spaces 22 of the hollow sections 10.

In such a torsion box 60, the respective webs 30 of the stiffening ribs 12 allow the flexural moment to be absorbed in the direction of alignment D, that is to say the transverse direction Y of the aircraft, as well as the shear forces in the vertical direction Z of the aircraft. In the particular case of a center wing box, it thus involves the bending stresses of the fuselage and the shear forces applied by the wings. Furthermore, the box-beams 40, which all extend on one and the same side of the box, outside the internal volume of the box, make it possible to absorb the loads associated with the supporting of a floor of the aircraft.

The box structure, formed by the walls 20 of the hollow sections 10 and the walls 36 of the flanges 32 of the stiffening ribs 12, makes it possible to absorb the flexural moments in the directions X and Z, that is to say the flexural loads applied by the wings, in the particular case of a center wing box.

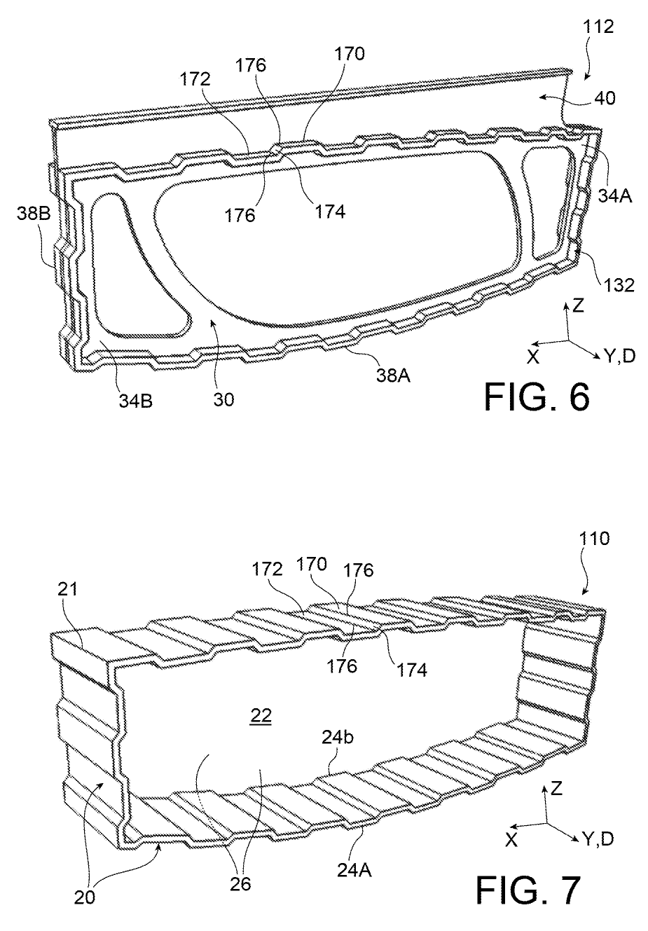

To this end, FIGS. 6 and 7 respectively illustrate variant embodiments of a stiffening rib 112 and of a hollow section 110, which are distinguished from the elements 12 and 10 described above by virtue of the fact that the hollow section 110 and the flange 132 of the stiffening rib 112 have corrugations, transversely to the direction of alignment D, in order to increase the stiffness of the hollow sections and of the respective flanges of the stiffening ribs, and to thus enhance their facility to absorb the flexural moments in the directions X and Z.

In the example illustrated, the corrugations are formed by an alternating arrangement of external parts 170 and of internal parts 172 linked in pairs by inclined planes 174, so as to define edges 176 at the joint of each external part 170 or internal part 172 with the adjacent inclined plane 174. In this example, these different parts are of substantially flat form. The corrugations thus have an angular or crenellated form. As a variant, the corrugations can be of sinusoidal form or, more generally, be formed by an alternation of convex and concave parts, or even be formed by an alternation of flat parts and of convex or concave parts.

Moreover, each hollow section 110 can be produced in a single piece by extrusion.

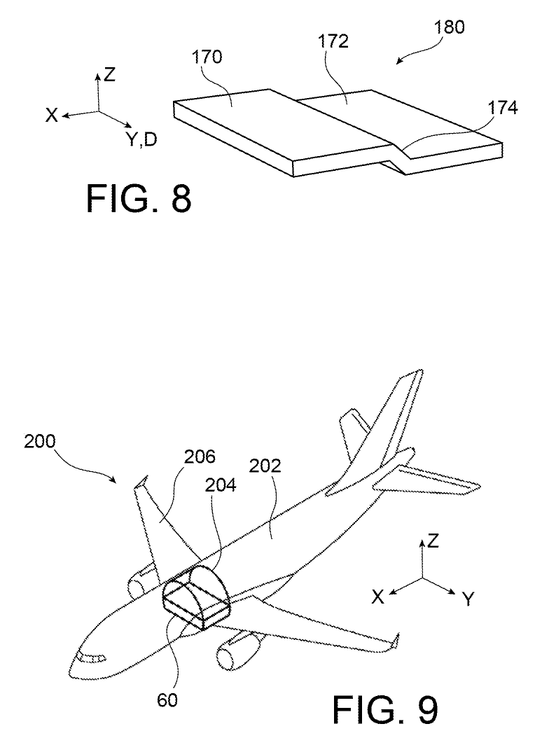

As a variant, each hollow section 110 can be obtained from individual sections 180, an example of which is illustrated in FIG. 8. This individual section 180 is formed by a plate having a recess defining a high or outer part 170 and a low or inner part 172, connected to one another by an inclined plane 174. Some of the individual sections also comprise a second inclined plane arranged at an end of the individual section, or a corner in order for the set of the individual sections to effectively make it possible to obtain all of a hollow section 110.

The production of a hollow section 110 in this case comprises the welding of the corresponding individual sections 180, in pairs.

In order to optimize the stiffness properties of the torsion box 60 while limiting the weight thereof, the hollow sections 10 or 110 and the flange 32 or 132 of each stiffening rib 12, 112 preferentially have a wall thickness lying between 5 mm and 10 mm, while the web 30 of each stiffening rib 12, 112 preferentially has a wall thickness lying between 3 mm and 8 mm.

To optimize the continuity of the airfoil loads, stiffeners can be attached to the outside of the torsion box.

FIG. 9 very schematically illustrates an aircraft 200, in this case an airplane, comprising in particular:

a fuselage 202 comprising, in particular, circumferential frames 204,

a center wing box composed of the torsion box 60 described above, to which are fixed some of the fuselage frames 204, and

wings 206, also fixed to the center wing box.

The invention is illustrated above in its application to a center wing box but can, as a variant, be applied to an outboard wing box.

Generally, the invention therefore makes it possible to considerably simplify the production of an aircraft torsion box, in particular through a drastic reduction of the variety of the parts forming the torsion box, through the production method according to the invention not requiring sealing operations at the joints between the different parts, and through the possibility of using extrusion to produce most of the parts forming the box. Furthermore, by avoiding the use of a large number of fixing members of bolt or rivet type, the invention also makes it possible to reduce the weight of the torsion box.

In a typical case of application, the invention makes it possible to increase the rate of production of the torsion boxes by a factor of 10, while halving the production cost and while allowing a lightening of the weight of the boxes of the order of 30%, notably through the elimination of 99% of the fixing members.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A torsion box for aircraft, comprising
hollow sections and stiffening ribs, arranged alternately one behind the other in a direction of alignment,
each hollow section having two opposing respective section edges and two opposing respective openings circumscribed by the two section edges respectively,
each hollow section being shaped so as to fully surround an internal space mutually linking the two openings of the hollow section, and
each stiffening rib comprising a respective web, and a respective flange which extends from the web all around the web, and which has two flange edges arranged respectively on either side of the web and respectively welded to two of the respective section edges of two corresponding hollow sections.

2. The torsion box according to claim 1, wherein each hollow section is formed of a single piece.

3. The torsion box according to claim 1, wherein each hollow section and the flange of each stiffening rib have corrugations extending transversely to the direction of alignment.

4. The torsion box according to claim 1, further comprising box-beams connected respectively to the respective flanges of the stiffening ribs and extending on one and the same side of the torsion box, outside of an internal volume of the torsion box delimited by the hollow sections and by the respective flanges of the stiffening ribs.

5. The torsion box according to claim 1, further comprising two end ribs arranged at two opposite ends of the torsion box and fixed respectively to two corresponding hollow sections.

6. An aircraft comprising at least one torsion box according to claim 1, forming a center wing box or an outboard wing box.

7. A method for producing a torsion box for aircraft, comprising the following steps:
providing hollow sections, each having two opposing respective section edges and two opposing respective openings circumscribed by the two section edges respectively, each hollow section being shaped so as to fully surround an internal space mutually linking the two openings of the section,
providing stiffening ribs, each comprising a respective web, and a respective flange which extends from the web all around the web, and which has two flange edges arranged respectively on either side of the web,
welding each of the two flange edges of the flange of each stiffening rib to a corresponding section edge of a corresponding hollow section, so as to obtain the torsion box, in which the hollow sections and the stiffening ribs are arranged alternately one behind the other in a direction of alignment.

8. The method according to claim 7, wherein the welding step is implemented by means of a butt-welding technique.

9. The method according to claim 8, wherein the butt-welding technique is selected from friction stir welding and laser welding.

10. The method according to claim 7, wherein the step of providing the hollow sections comprises production of the hollow sections by extrusion.

11. The method according to claim 10, wherein the production of the hollow sections by extrusion comprises, for each of the hollow sections, the production by extrusion of individual sections and then an assembly of the individual sections by welding.
